(19) United States
(12) Patent Application Publication
(10) Pub. No.: US 2026/0244713 A1
(43) Pub. Date: Aug. 20, 2026

(54) SYSTEM AND METHOD FOR REAL-TIME DATA CATEGORIZATION

(71) Applicant: Incucomm, Inc., Addison, TX (US)

(72) Inventor: Christopher Scott Heinlen, Dallas, TX (US)

(73) Assignee: Incucomm, Inc., Addison, TX (US)

(21) Appl. No.: 19/406,851

(22) Filed: Dec. 2, 2025

Related U.S. Application Data
(63) Continuation-in-part of application No. 18/475,963, filed on Sep. 27, 2023.
(60) Provisional application No. 63/377,278, filed on Sep. 27, 2022.
(60) Provisional application No. 63/726,814, filed on Dec. 2, 2024.

(51) Int. Cl. G06F 18/2323; G06F 18/2135; G06F 18/231

(52) U.S. Cl. CPC G06F 18/2323; G06F 18/2135; G06F 18/231

(57) ABSTRACT

A data categorization system and corresponding method for real-time data categorization of streaming data. In one embodiment, the system checking the streaming data against known data clusters and assign ones of the streaming data that fit the known data clusters thereto, otherwise categorize the ones of the streaming data as unclassified data. The system executes unsupervised clustering on the unclassified data to generate new data clusters. The system defines shells for the new data clusters to add to the known data clusters. The data system outputs the new data clusters to a data analysis system to execute a model to operate a real system with computational efficiency in real-time.

### CROSS-REFERENCE TO RELATED APPLICATION

This application is a continuation-in-part to U.S. patent application Ser. No. 18/475,963 entitled “System and Method for Real-Time Data Categorization,” filed Sep. 27, 2023, which claims the benefit of U.S. Provisional Patent Application Ser. No. 63/377,278, entitled “An Improved Method for Unsupervised, Noisy-Data-Stream Clustering,” filed on Sep. 27, 2022, and also claims the benefit of U.S. Provisional Patent Application Ser. No. 63/726,814, entitled “System and Method for Real-Time Data Categorization,” filed on Dec. 2, 2024, which are incorporated herein by reference.

### TECHNICAL FIELD

The present disclosure is directed, in general, to real-time data categorization and, more specifically, to systems and methods for dynamically categorizing streaming data output from a data collection system.

### BACKGROUND

Artificial Intelligence and Machine Learning (AI/ML) techniques are generally brittle; that is, they are prone to failure if there are any discrepancies between training and application. This means that an AI/ML technique may perform well when analyzing a discrete dataset, but that performance will fall apart when new data is added to the model. This degradation is apparent when new data belonging to existing categories is injected into the model but is even more pronounced when a new type of data, previously unseen, is added to a model. Because of this, traditional AI/ML solutions generally need to be retrained if a new category of data is added to the system. Additionally, many AI/ML solutions do not have a mechanism to detect outliers or noise; instead, they force such data points into categories they do not belong to.

Many approaches to AI/ML rely on the premise that there is well-labeled training data. In many scenarios, however, such reliance is not feasible or even possible. In those cases, unsupervised learning approaches attempt to automatically discern patterns or class types within the data. Applications that deal with streaming or batched data that contain unknown or evolving class types typically fall into this category. A problem with many off-the-shelf algorithms is that they are designed to look at a single batch of data in isolation. These same off the shelf algorithms also do not address noise as an acceptable category. This can cause inefficiencies and inaccuracies when applied in streaming environments. Implementers are forced to incorporate some form of reconciliation or deduping of classes. Knowledge learned from historic data is not leveraged when analyzing current data.

Accordingly, there is a need in the art for systems and methods that overcome those deficiencies; in particular, there is a need in the art for systems and methods for real-time data categorization designed to handle streaming, infinite datasets and to dynamically add new classification types as new data types are seen. Additionally, higher dimensional clustering of the new data types would be beneficial.

### SUMMARY

To address the deficiencies of the prior art, disclosed hereinafter are a data categorization system and corresponding method for real-time data categorization of streaming data output from a data collection system.

In one embodiment, the data categorization system dynamically categorizes streaming data into data clusters; the data categorization system having no prior knowledge of the data clusters to which the streaming data can be assigned. The data categorization system being operable on a processor and memory configured to check the streaming data against known data clusters and assign ones of the streaming data that fit the known data clusters thereto, otherwise categorize the ones of the streaming data as unclassified data. The data categorization system further configured to execute unsupervised clustering on the unclassified data when the unclassified data reaches a threshold, the unsupervised clustering configured to generate a minimum spanning tree of the unclassified data, generate a dendrogram from the minimum spanning tree including nodes having ones of the unclassified data, determine which nodes are viable as new data clusters, and cull noise and extraneous ones of the unclassified data from the new data clusters; the unsupervised clustering producing a transformed and reduced set of the unclassified data within the new data clusters. The data categorization system further configured to define shells for the new data clusters by determining a transformation that forces the unclassified data into a unit sphere or cube, applying the transformation to each of the unclassified data, and assigning any of the unclassified data that fall within the unit sphere or cube to the shells for the new data clusters; the shells including a transformed and reduced set of the unclassified data to add to the known data clusters. The data categorization system further configured to output the new data clusters to a data analysis system to execute a model to operate a real system with computational efficiency in real-time.

The foregoing has broadly outlined the essential and optional features of the various embodiments that will be described in detail hereinafter; the essential and certain optional features form the subject matter of the appended claims. Those skilled in the art should recognize that the principles of the specifically disclosed embodiments and functions can be utilized as a basis for similar systems and methods that are within the scope of the appended claims.

### BRIEF DESCRIPTION OF THE DRAWINGS

For a more complete understanding of the present disclosure, reference is now made to the following detailed description taken in conjunction with the accompanying drawings, in which:

FIG. 1 illustrates four categories of concept drift for streaming data;

FIG. 2 illustrates an exemplary real-time data categorization system;

FIG. 3 illustrates Delaunay triangulation of an exemplary data cluster and noise;

FIG. 4 illustrates an exemplary two-dimensional data point set and its resulting Parzen Window Density Estimation;

FIG. 5 illustrates exemplary unsupervised clustering of three-dimensional data;

FIG. 6 illustrates exemplary cluster bridging;

FIG. 7 illustrates an exemplary shell and corresponding data points;

FIG. 8 illustrates an exemplary minimum spanning tree of a three-cluster dataset;

FIGS. 9A and 9B illustrate exemplary graphical representations of timing comparisons (in seconds (s) on the vertical axis) verses a number of data points (on the horizontal axis) between Wang's implementation and the implementation for structured and unstructured data with datasets of varying sizes according to the system and method disclosed herein;

FIG. 10A illustrates an exemplary dataset's dendrogram;

FIG. 10B illustrates exemplary data points that make up each of five clusters;

FIG. 11 illustrates an exemplary plot demonstrating the relationship between λ and the resulting clusters for a λ-value for a three-cluster dataset;

FIG. 12 illustrates an exemplary plot for a noisy dataset containing two distinct clusters;

FIG. 13 illustrates an exemplary plot of an ill-formed dendrogram;

FIG. 14 illustrates an exemplary plot of a labelling comparison of noise rejection between the system and method disclosed herein and HDBSCAN;

FIGS. 15A and 15B illustrate exemplary plots of time to execute comparisons across dataset lengths with a fixed dimension for structured and unstructured data, respectively; and

FIGS. 16A and 16B illustrate exemplary plots of time to execute comparisons across dimensions with a fixed dataset length for structured and unstructured data, respectively.

Corresponding numerals and symbols in the different figures generally refer to corresponding parts unless otherwise indicated and, in the interest of brevity, may not be described after the first instance.

### DETAILED DESCRIPTION

The system and method (also referred to as “process,” and often just referred to as “system”) described hereinafter overcome certain deficiencies of the prior art; in particular, the system and corresponding method are designed to handle streaming, infinite datasets and to dynamically add new classification types as new data types are seen. The system is not limited to a certain number of classification types and does not need to be retrained as new data types are introduced; thus, making it efficient and adaptable. Additionally, it can detect outliers and noise and categorize them as such.

There are three overarching branches of machine learning which dictate how data is processed: supervised, unsupervised, and reinforcement learning. Supervised learning is a model created with data whose input and output are known. Supervised learning can be broken down into regression techniques for continuous response prediction and classification techniques for discrete response predictions. Unsupervised learning deals with unknown data and employs clustering techniques to identify patterns within the data; this type of learning can be broken down into hard clustering and soft clustering. Hard clustering puts each data point (also referred to as “data”) into one, and only one, cluster while soft clustering can assign a data point to multiple clusters. Finally, a reinforcement learning model is trained on successive iterations of decision-making, with rewards given based on the results of those decisions.

Traditional machine learning deals with a static dataset, but there are many use cases which necessitate the ability to classify data points within an endless data stream. Streaming data, as opposed to a static dataset, presents distinct challenges for data classification. One such challenge is concept drift which is described in Data Stream Clustering: A Review by Zubaroğlu, A. and Atalay, V., (2020) (see: https://doi.org/10.48550/arXiv.2007.10781). Concept drift is a change in the properties or features within a data stream over time, which can be broken down into four categories: sudden, gradual, incremental, and recurring.

Dynamic, Unsupervised Clustering by Algorithmic Thresholding (DUCAT), first presented at I/ITSEC 2023 and the subject of A Novel Approach to Dynamic Unsupervised Clustering (Heinlen, Volpi, and Allen, 2023) and U.S. patent application Ser. No. 18/475,963 both incorporated herein by reference, is a system designed to handle noisy, streaming data. When DUCAT identifies new class types, it codifies them so new data entering the system can be quickly checked for inclusion in previously identified classes. This removes the need for an external mechanism to reconcile classes and reduces the amount of data that needs to be searched for emergent clusters. Additionally, DUCAT is designed for noisy environments and can maintain tight cluster definitions even in situations with large amounts of noise. It would be beneficial to allow for higher dimensional clustering and increased overall performance.

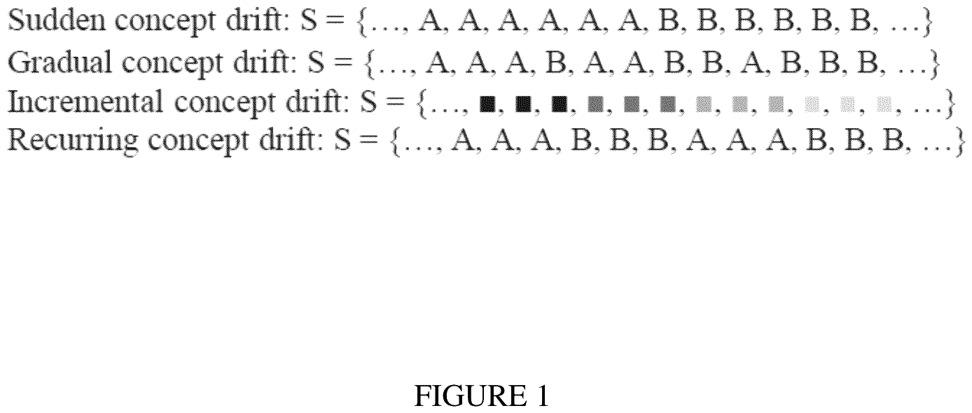

FIG. 1 illustrates the four categories of concept drift for streaming data: sudden, gradual, incremental and recurring concept drift. To understand each of these types of drift, consider a data stream S comprised of data points with features A and features B. As illustrated in FIG. 1, sudden concept drift is a feature change that occurs instantaneously between two neighboring data points in time; before and after the change the features present in the data are static. As also illustrated in FIG. 1, gradual concept drift occurs when two distinct feature sets are present in the data; the first feature set A is initially present by itself but over time the second feature set B becomes interspersed in the incoming data until eventually the second feature set is the only feature present.

Next, incremental concept drift describes a slow change from one feature set to another; this change occurs incrementally from one data point to the next as the original feature set morphs into a completely different feature set. As illustrated in FIG. 1 for incremental concept drift, consider a data stream initially consisting of data points with a black feature and, after a period of time, the data stream consists of a light grey feature. During the transition from black to light grey, the data points will be comprised of a combination of the starting feature and the ending feature causing the data points to gradate from black to light gray. Finally, recurring concept drift refers to two distinct feature sets A and B switching between themselves over time, neither disappearing completely from the data stream and each returning in turn.

The system and method described herein (also referred to as “DUCAT”) innovatively utilizes soft, unsupervised clustering to classify streaming data without the need for any prior knowledge of the data, including the number of classification types within the data stream. Additionally, because the classification types are dynamic, the disclosed system—unlike prior art systems and methods—can overcome issues stemming from concept drift.

There are a plurality of applications in which the disclosed system and method can be advantageously employed. For example, the disclosed real-time data categorization system or DUCAT can be used to identify radar pulses in real time, without knowledge of the type of pulses that are present or can be applied to financial data to find anomalies or to find and track the occurrence of a specific transaction type. The disclosed system can also be utilized for real time analysis of data collected from any type of sensor and behavior changes or anomalies could be automatically found. Similarly, the system can be applied to communication data for behavioral analysis. In general, the disclosed system and method can easily be applied to any streaming data with discrete data instances containing some number of features, can dynamically classify those instances into categories or flag them as an outlier, and can use the categorized or clustered data to control, operate, maintain (maintenance), predict and prescribe actions for real-time systems such as, without limitation, industrial, commercial and military systems.

The disclosed system is capable of being coupled with a data streaming system like Lone Star Analysis' AOS Edge Analytics, disclosed in U.S. Pat. No. 10,795,337, which issued on Oct. 6, 2020 and is incorporated herein by reference. AOS Edge Analytics provides an infrastructure for data to be captured and streamed, and this infrastructure can be utilized to feed the data to the system disclosed herein. Additionally, the disclosed system is closely tied to Lone Star's Correlated Histogram Clustering (CHC) system and method, as disclosed in U.S. patent application Ser. No. 17/808,093, filed on Jun. 21, 2021 and is incorporated herein by reference, in that both are novel methods of unsupervised clustering. The distinction in utility between CHC and the system disclosed herein is that CHC analyzes a static dataset and determines cluster centroids while the system disclosed herein analyzes streaming data and determines cluster membership of individual data points. Lone Star's Evolved AI©, as disclosed in United States Patent Publication No. 2020/0193075, dated Jun. 18, 2020 and is incorporated herein by reference, is also related to the system disclosed herein in that both are explainable and transparent approaches to artificial intelligence. Additionally, these solutions do not require massive data lakes, nor do they rely on many-layered neural networks to make decisions. Evolved AI® systems and methods employ stochastic non-linear optimization.

One embodiment of the disclosed system, which will be further elaborated later herein, relies heavily on Delaunay triangulation. Delaunay triangulation is a specific triangulation method which creates connections between data points in a data point set. To explain what a triangulation is, De Loera defines a few concepts first:
A Point Configuration is a finite set of data points A={a₁, . . . , aₙ} that exist in [symbol] ^{d}
The Convex hull of A, conv(A), is the intersection of all convex sets containing the data points in A.
A simplex is the simplest possible polytope (flat sided geometric object) in n-dimensions; a 0-simplex is a data point, a 1-simplex is a line segment, a 2-simplex is a triangle, a 3-simplex is a tetrahedron, and so on. Formally, a k-simplex is the convex hull created from k+1, affinely independent, vertices. Affinely independent refers to a set which, when one member is subtracted from the set, becomes linearly independent. A k-simplex is comprised of a number of j-faces which are themselves simplices consisting of j+1 vertices. A j-face can be any simplex from −1, an empty set, to k.
   Given those definitions, a triangulation of A in [symbol] ^{d} can be defined as a finite collection of d- [symbol] simplices of A that satisfy the two requirements:
1. The union of the simplices is equal to conv(A); and,
2. Any two simplices intersect in a common face (possibly empty).
   For most datasets there are multiple possible triangulations; the triangulation method described herein is the Delaunay triangulation, which for any given set of data points has just a single triangulation. The specifics of Delaunay triangulations are further described later herein.

Triangulations are a subset of tessellations and have many different applications. They are typically used to generate meshes and can be applied in the fields of 3D modeling, finite element analysis, terrain mapping, and path planning, amongst others. For the system described herein, it is used as a way of determining a data point's neighbors without predefining the number of neighbors that data point has. A traditional method of defining neighbors is k-nearest neighbors which defines a data point's neighbors as the k closest other data points; the drawback to this method is that every data point will not necessarily have the same number of relevant neighbors. By using Delaunay triangulation, a data point's neighbors can be defined as the data points that are vertices of a common simplex; thus, the number of neighbors a data point has is dynamic and depends on the geometry of the data point set (also referred to as “dataset”). This is advantageous because a data point in the middle of a cluster may have more relevant neighbors than a data point on the exterior of a cluster.

While the embodiments described herein utilize Delaunay triangulation, other triangulation or tessellation techniques could be used as well as other techniques disclosed herein or otherwise. If a scale invariant tessellation was utilized, that feature could be leveraged to find locations of interest on a macro level; further analysis could then be performed on these locations of interest. This method of zooming in on areas of interest, or selective analysis, would be beneficial for problems with high dimensionality and large search spaces. By being discerning about where a full analysis is performed, computation times can be reduced.

The system described herein is designed for unsupervised clustering in dynamic and noisy environments, highlighting its applications in real-time data analysis and anomaly detection, classifying noisy data streams without human intervention. The system is designed to efficiently and accurately identify and define an unknown number of clusters, each with unknown features. Additionally, the system maintains high performance in a noisy environment. In an ideal world, the system can operate with training data, and a dataset can be observed in its entirety. However, that luxury is not always available. In many real-time streaming applications, training data is not feasible due to the unpredictability of future clusters, and real-time classifications prevent the luxury of analyzing the data in aggregate. The system enables classification decisions based on historical data and the clusters identified therein, while also allowing for the detection of emerging clusters in current and future data streams.

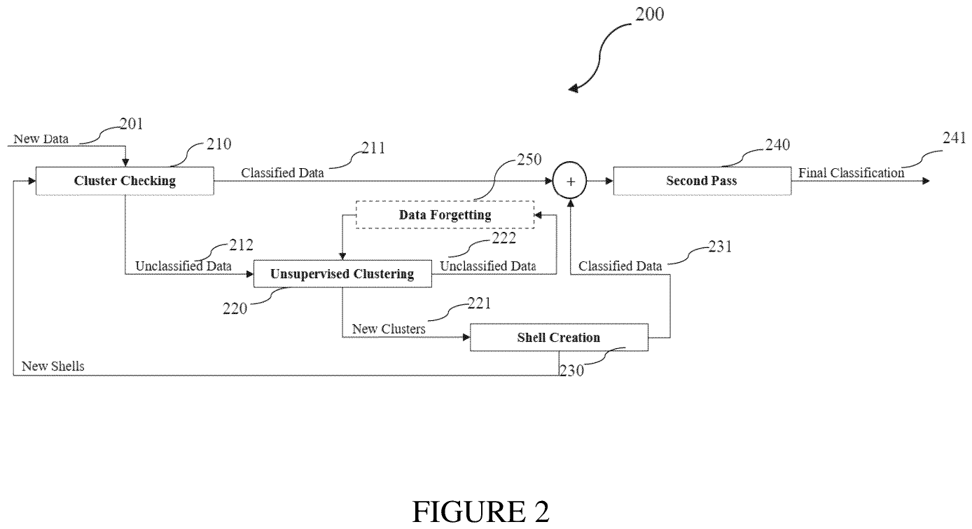

FIG. 2 illustrates an exemplary real-time data categorization system (also referred to as a “system” or DUCAT) 200 according to the principles of the invention; the system 200, and corresponding method, can dynamically categorize streaming, noisy data without prior knowledge of what categories (or clusters, also referred to as “data clusters”) or how many categories exist within the input data (or data point) (“New Data”; 201). Unlike many prior art approaches, the system 200 does not force every data point into a category and is therefore especially useful when analyzing noisy data as it allows a data point to be classified as noise. The system 200 can be configured down into four distinct modules/functions (210, 220, 230, 240) which work in tandem to categorize incoming data 201 and create new category buckets as they appear in the data, yielding a final classification 241 for all input data 201. The system 200, including each of the means (or modules/functions) 210, 220, 230 and 240, can be implemented in one or more processors and memories, wherein the one or more memories contain instructions which, when performed by the one or more processors, are operative to perform the functions disclosed hereinafter.

First, the system 200 comprises means or cluster checking module 210 for checking each one of the input or incoming data (“New Data”; 201), as received, against any known data categories. In other words, the input data 201 is first checked against previously found clusters. If the one of the new data 201 fits one or more of the known data categories (or clusters), classifying the one of the new data according to the one or more of the known data categories (“Classified Data”; 211), otherwise adding the one of the data to a pool (or unlabeled pool) of unclassified data (“Unclassified Data”; 212). Thus, new data 201 that does not belong to any existing classes or clusters is added to an unlabeled pool that is periodically processed with the unsupervised clustering algorithm to search for emergent clusters. More particularly, means 210 is operative to, for each new data point 201 entering the system 200, test the new data point 201 against existing (or known) data categories (or clusters); such categories may be predefined or learned from previous input data. The system and method of testing will depend on how a shell is defined by the system and method for shell creation described hereinafter. One embodiment is to use a node-based definition in which nodes are created in the general area of the cluster and then defined as being included or excluded from the shell. In such embodiments, each incoming data point 201 is transformed into each existing cluster's nodal space and then checked for cluster inclusion. The creation of this nodal space will be explained in more detail hereinafter.

Shells can be defined in a plurality of ways, but regardless of how the shell is defined it will have a method of checking for inclusion, and that check will be the first step for any new data 201 entering the system 200. In one embodiment, a shell could be defined by an equation in spherical coordinates; a new data point 201 would be checked for inclusion by evaluating the equation at the new data point 201 and determining if the data point's radius is within the radius defined by the equation. Another potential embodiment would be to use a surface to define the shell; by checking whether a data point falls inside or outside of that surface cluster, inclusion can be determined. After this check, the new data point 201 will either be categorized as belonging to an existing cluster or not. A new data point 201 can potentially belong to multiple clusters because categories are defined independently. This independence can result in multiple clusters overlapping. This is intentional and the means for a second pass or second pass module 240 described hereinafter, in part, tries to reconcile any such overlaps. In the case that a new data point 201 does belong to a cluster, which will be reported; in the case that it does not, it gets added to a pool which will go on to the means for unsupervised clustering or unsupervised clustering module 220 portion of the system.

Thus, when a new data cluster is found within the unclassified pool, that cluster is given a concrete definition by the shell creation module (see below) which is then added to the library that new data 201 is checked against upon entry to the system. Labeled data is aggregated and given a final review in the optional second pass module 240. This module serves as an opportunity to refine cluster definitions, merge or split classes, or leverage any apriori knowledge known about the data stream.

Next, the system 200 comprises means or unsupervised clustering module 220 for, when the pool of unclassified data (also referred to as “unclassified data”) 212 reaches a threshold, executing an unsupervised clustering method on the unclassified data to identify any previously uncategorized data clusters and define one or more new data categories for any such previously uncategorized clusters (“New Clusters” or “New Data Clusters”; 221); if a new category, or cluster, is found, the new cluster 221 is input to a means to define a shell or shell creation module (230) with which subsequent new data 201 can be checked against to determine inclusion.

More particularly regarding means 220 for executing an unsupervised clustering method, when the pool of unclassified data 212 reaches a predetermined threshold, the system 200 will attempt to find new clusters within those data points. The threshold can be a function of the streaming speed of the incoming data and how often the user wants to check for newly forming clusters; i.e., the threshold can be a function of the data rate of the streaming data and, if desired, a function of a predefined temporal interval. The unsupervised clustering method can be applied to high dimensional data but, for the ease of visualization, will be described herein with respect to two- and three-dimensional examples. The means 220 for executing an unsupervised clustering method does not need any prior knowledge of the input data 201 and returns groupings, or clusters, of like data within the complete set. While this form of unsupervised clustering does not depend upon prior knowledge, in the case where the user does have prior knowledge, additional thresholds and discriminators can be added to the process. Additionally, the unsupervised clustering method can isolate clusters from surrounding noise so that every point need not belong to a found cluster. Identifying clusters within the data is critical as it allows the system to categorize data by type and isolate relevant data from noise.

In one embodiment of the means 220 for executing an unsupervised clustering method, the first step is determining the distances between each data point and its neighbors in the dataset. There are a plurality of distance metrics that could be used and, depending on the dataset, different distance metrics may yield better or worse results. The most straight-forward metric is Euclidean distance, in which the differences between the features of two data points are squared and summed and the distance between the two data points is the square root of that sum:

$$d ( p , q ) = \sqrt{{\sum }_{i = 1}^{n} {( {q}_{i} - {p}_{i} )}^{2}}$$

Determining what constitutes a neighbor is another aspect of the method in which a plurality of approaches could be taken; the exemplary embodiment described here uses Delaunay triangulation. In two dimensions, Delaunay triangulation is a triangulation method for a set of discrete data points in which the resulting circumcircles of the created triangles contain only the data points at the vertices of the triangle and no other data points from the dataset. By using this method, the resulting triangles have interior angles whose minimum is maximized, and maximum is minimized; this makes the triangles tend towards being as close to equilateral as possible. The process, however, is not limited to two dimensions—by using simplices instead of triangles and circum-hyperspheres instead of circumcircles, the Delaunay triangulation is unlimited and can be determined in n-dimensions. This is significant because the system and method disclosed herein is not constrained to only analyzing two-dimensional data, but can be applied to data with many features.

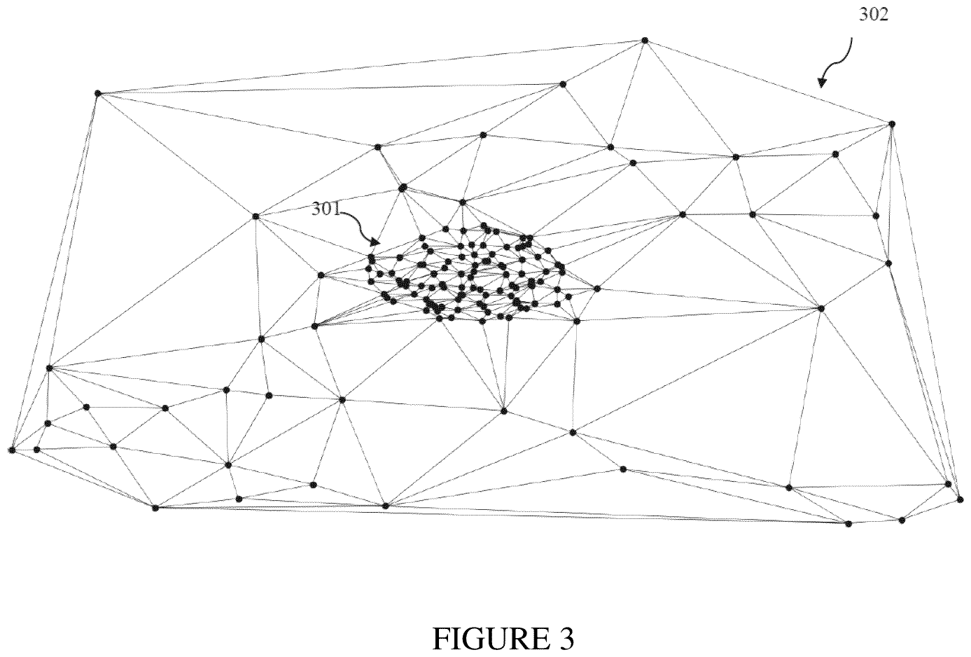

Turning now FIG. 3, illustrated is Delaunay triangulation of an exemplary data cluster and noise; more specifically, a two-dimensional data point set and its resulting Delaunay triangulation. The data points are represented as black dots and the edges of the triangles as lines therebetween. The exemplary dataset contains a tightly packed cluster 301 surrounded by noise data points 302. The triangles within the cluster are much more compact than those in the noise areas; this difference in size, specifically the difference in edge length, is what unsupervised clustering means 220 uses to easily determine whether or not a cluster exists within a dataset.

Each data point in a dataset will be part of one or more simplices defined by Delaunay triangulation and the points on the other vertices of these simplices are considered to be the original point's neighbors. With a distance metric and defined neighbors, the distances between every neighbor can be calculated and aggregated. The distances can then be histogrammed to determine the most prevalent neighbor spacing in the data. If the input data 212 is pure noise, the histogram would be expected to follow a Gaussian distribution. If a cluster exists in the data, however, the histogram will show a peak at the distances within the cluster and if noise is present, the overall histogram will skew right. This is due to the noise generally being spread further apart than the points within a cluster. Additionally, if there are multiple clusters, each with their own densities, the histogram will result in a multi-modal distribution with peaks corresponding to each of the clusters. Based on the location of the peak(s) of the histogram and the spread associated with that peak, a threshold distance, or multiple thresholds in the case of a multimodal distribution, can be easily determined to identify clusters and classify points.

In an alternative embodiment of unsupervised clustering means 220, Parzen Window Density Estimation (PWDE) is used to determine the distance threshold. The PWDE is defined with the following equation:

$$p ( x ) = \frac{1}{n} {\sum }_{i = 1}^{n} \frac{1}{V} ϕ ( \frac{{x}_{i} - x}{h} ) ,$$

where φ is a window function, h is the window width, V is the volume of the window, n is the number of points in the dataset, x is location at which the density estimation is evaluated at, and xᵢ are the points in the dataset. The simplest PWDE uses a hypercube as the window, in this case V=h^{d}, where d is the number of dimensions the dataset contains; while a hypercube provides a simple PWDE implementation, the window function is not restricted to a hypercube and can take on any geometry.

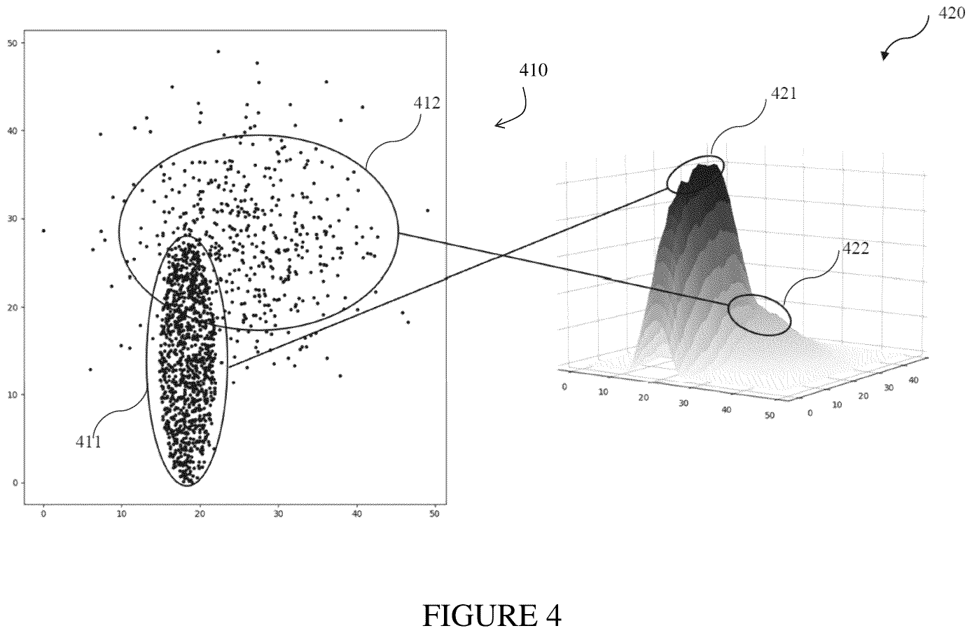

Now referring to FIG. 4, illustrated is an exemplary two-dimensional data point set 410 and its resulting Parzen Window Density Estimation 420; the data point set 410 contains two overlapping clusters 411, 412 with different densities. The peak 421 of the PWDE 420 can be used to determine a distance threshold capable of defining the dense cluster 411. Additionally, there is a second lower peak 422 that corresponds to the sparser cluster 412. Similar to the embodiment utilizing histograms, a second threshold can be calculated based off of this second peak that is capable of defining the sparse cluster.

Once a distance threshold (or thresholds) is determined, the classification process begins by choosing an arbitrary data point in the dataset and determining the distance between itself and each of its neighbors. If any of the neighbors are within the distance threshold, the original data point and the close neighbor are considered to be within the same cluster. The close neighbors of the original data point are then selected, and their neighbors are evaluated for cluster inclusion. This process is repeated until there are no more neighbors of any of the data points in the newly defined cluster that are within the threshold distance. This collection of data points is defined as a single cluster. After the cluster is fully defined, another arbitrary, undefined data point is selected, and the process is repeated. This continues until all the data points in the dataset are either defined to be a part of a cluster or are further than the threshold from all their neighbors.

Another embodiment of the cluster generation process considers cluster seeds instead of choosing arbitrary data points to begin the clustering process. Consider, for example, the PWDE method of determining thresholds. Each threshold can be associated with a location within the problem space and the location can then be associated with a specific data point within the data being analyzed. The data point(s) associated with the threshold(s) generated can then be used to begin the clustering process, allowing the thresholds to be localized to the spatial region they were defined in. This process allows for a more efficient cluster generation as clusters are generated only around seed data points as opposed to the method described previously in which the dataset is fully defined.

At this data point, there are two parameters that define whether a cluster is worth reporting or not. The first is the minimum cluster size; this parameter sets a baseline threshold for the size of clusters. Any clusters found that are smaller than the minimum threshold are reclassified as noise. The minimum cluster size is set at the user's discretion and serves to quantify the minimum number of occurrences needed to define a new data type. The second is the maximum cluster percent; this parameter is to prevent a dataset that is comprised of only noise from being classified as one large cluster. This parameter is a set percentage and if a cluster is comprised of data points that are a greater percentage of the whole dataset than the parameter, the cluster is reclassified as noise. This parameter will generally be close to one. Additional methods of culling out clusters can be implemented at this stage, depending on if there is any leverageable prior knowledge about the data being analyzed.

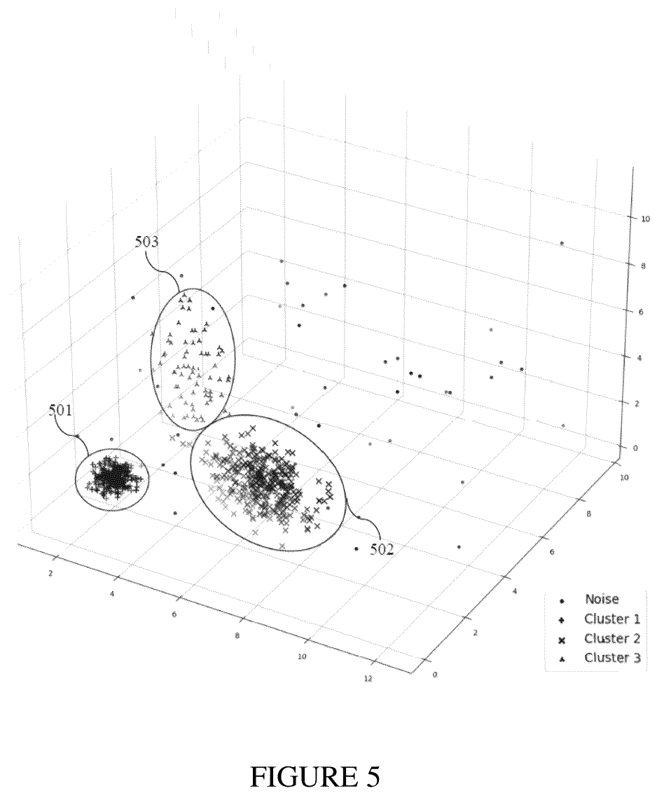

FIG. 5 illustrates the results of running the unsupervised clustering system and method on a set of three-dimensional data. The data consists of three clusters (represented by “+” for Cluster 1 (501), “x” for Cluster 2 (502), and “\hat{ }” for Cluster 3 (503)), all of which have different sizes and densities, and noise data points (represented by “.” for Noise). The described means for unsupervised clustering 220 is able to correctly and easily identify all three clusters and assign membership to each of the three clusters, while also identifying the noise data points; it is not restricted to a single cluster density, it easily finds Cluster 3 503 even though it is much sparser than the other two clusters. This difference in density could be a result of a newly appearing data type or a less common data type—in either case, the disclosed means 220 is equipped to identify the cluster.

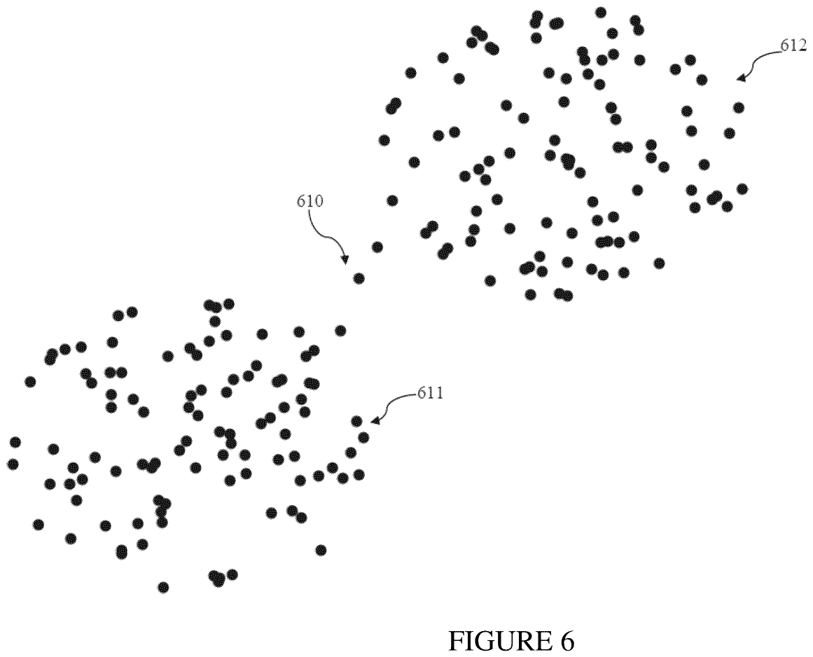

The shell creation process performed by means 220 can be susceptible to bridging between clusters. In an exemplary case illustrated in FIG. 6, bridging occurs when there is a thin band of noisy data points 610 that span between two clusters 611, 612. Because the disclosed method of unsupervised clustering performed by means 220 is just looking at the distance between neighbors, bridging can cause two distinct clusters to merge into a single cluster. Bridging can be successfully combatted in a plurality of different ways. One way is by analyzing local densities to detect bridging. Another way is to look at the shapes of the simplices within the cluster; true members of the cluster will tend to be a part of simplices that are closer to equilateral, while data points that make up a bridge will tend to be members of very thin simplices. Another method of combatting bridging is to analyze the subset of edges from the Delaunay triangulation which are shorter than the distance threshold; data points that make up a bridge will be connected to edges whose interior angle will tend towards 180 degrees, and a threshold angle can be set to identify these data points. Additionally, the process described hereinafter for the second pass module 240 of system 200 will also combat bridging.

Depending on the amount of data being ingested, the length of time the stream is running, and how noisy the data is, means for forgetting or data forgiving module 250, or removing, unclassified data 222 may be needed and is easily incorporated into system 200. As the system 200 runs, the unclassified pool will continue to grow as more and more outliers, or noise data points, are seen. Left unchecked, the unclassified pool could grow to a size that hampers performance and slows the system, so a method of forgetting may need to be established. The means for forgetting 250 can take multiple forms; a simple solution would be a hard cap on either time or size. That is, if a data point is older than a threshold, it will be discarded or, if a pool is above a threshold, data points will be removed. Alternatively, a soft cap can be implemented, wherein after a certain threshold, either in time or in pool size, a sampling of data points is removed as a way of retaining some of the older information in the unclassified pool.

The disclosed unsupervised clustering process performed by unsupervised clustering means 220 is just one of many possible embodiments; this portion of the system 200 could be accomplished with a density-based clustering system, another distance-based system, or any other unsupervised clustering method.

Next, the system 200 comprises means for shell creation 230; more particularly, means for, if one or more new data categories are defined in previously uncategorized data, using each of the previously uncategorized clusters 221 to define a shell for which previously unclassified data 212 can be checked for inclusion and assigning any such unclassified data within the shell to the new data category. Once a new cluster 221 is identified by unsupervised clustering 220, the data points that comprise that cluster 221 are used to create a new shell against which new data points can be compared. As described previously, there are a plurality of ways to define the cluster shell, but an exemplary nodal embodiment is described herein. Delaunay triangulation can be used once again, this time to determine a pseudo-density for a cluster. Using Delaunay triangulation, the median edge distance of the simplices of the cluster can be calculated. If a new data point is within that median distance, multiplied by some predefined multiplier, of any data point within the cluster, it is likely also a part of the cluster. The predefined multiplier determines how conservative the shell should be. For example, if the multiplier is set to one, the shell will only encompass the space that is within the median distance from the data points used to originally define the cluster; if the multiplier is set above one, the boundary of the shell will expand and include more of the surrounding space.

It would be computationally inefficient to calculate the distance of a new data point from every data point that makes up an existing cluster, so a nodal system is innovatively incorporated within the system 200. The distances can be precomputed, and a new data point simply needs to be compared against an existing dictionary of nodes to determine cluster inclusion. The first step in the process is to define a nodal space and create a conversion factor to go between real space (raw feature values) and the cluster's nodal space. This conversion is shown below:
for i in range(point.dimensions):

$$point [ i ] = round ( ( ( point [ i ] - x\_min [ i ] ) * ( nodes - 1 ) ) / x\_range [ i ] ) ,$$

where “point” is the data point being converted into the nodal space, “nodes” is the number of nodes in each dimension, “x_min” are the minimum values of the data points that make up the cluster in each feature dimension, and “x_range” are the range of values of the data points that make up the cluster in each feature dimension. The median edge distance multiplied by the multiplier is subtracted from each “x_min” value and twice that value is added to each “x_range” value so that the entirety of the possible cluster area is included within the nodal space. Finally, the point is rounded to the nearest whole number resulting in a n-dimensional coordinate with values between zero and the number of nodes minus one. By converting from a continuous real space to a discrete nodal space, the inclusion or exclusion of the finite number of nodes can be precomputed; this makes checking new data points for inclusion simple and fast.

The data points that comprise the new cluster are converted into nodal space without the rounding step and the median edge distance is recomputed within this space. Then, if the minimum distance between a given node and a member of the cluster is less than the median edge distance multiplied by the multiplier, that node is flagged as a part of the cluster. These flagged nodes can be saved to a dictionary with their node space coordinates as keys and a Boolean return to make it easy to quickly determine membership of new data points.

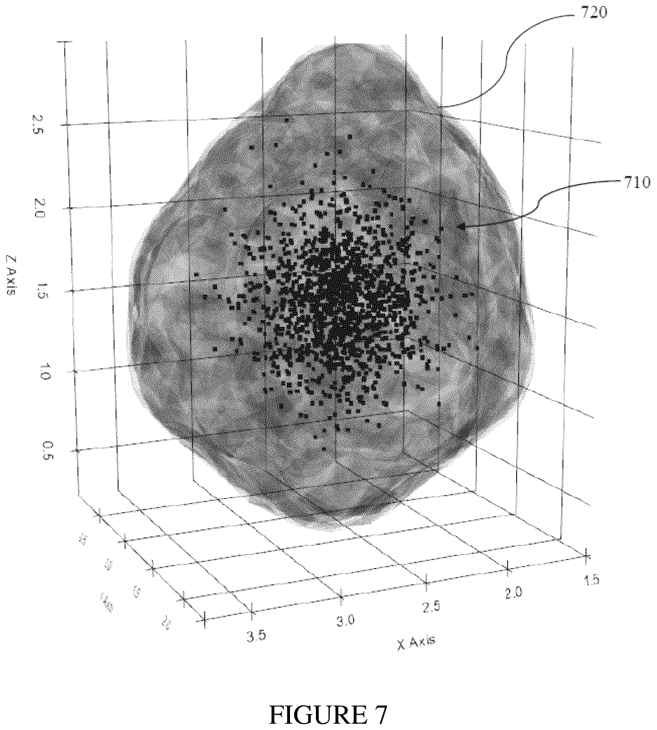

Reference is made to FIG. 7, which illustrates an exemplary shell and corresponding data points. For this example, a three-dimensional cluster of data points, represented by the black dots 710, are used to generate a shell 720 using the disclosed system and method; the grey cloud surrounding the data points 710 represent the shell 720 created by this system—that is, any new data point that falls within the grey cloud will be identified as belonging to this cluster.

To decrease the time to process a new data point, a coarse shell can be implemented before converting a new data point to a cluster's nodal space. In the case of a large dataset with many categories, it may become time consuming to convert each new data point into every cluster's node space, so a rough check before performing the conversion is useful and compatible. This can be accomplished by comparing the x_min and x_range values in the conversion equation to the data point in real space. If any of the features are less than their corresponding x_min value or greater than their corresponding x_min plus x_range value, then the data point will not fall into that cluster and the conversion to nodal space is not necessary. This initial check allows the system to identify new data points more quickly.

An alternative embodiment of the shell creation process performed means 230 is to generate a representative group of data points that occupies the same spatial region as the data points that comprise the cluster. Vector Quantization (VQ) is one method of achieving this task, but there are a plurality of methods that could be used to generate the representative data points. With a representative group of data points, distance threshold(s) can be determined. One version of this embodiment uses a single threshold for the entire shell, but individual thresholds can be created for each representative data point. The thresholds can be defined based on the relative spacing of the representative data points and the original data points that made up the cluster. Once the representative group and the threshold(s) have been generated, new data points can be checked for cluster inclusion by determining the distance of each new data point from each of the representative data points; if any of those distances are within the threshold corresponding to the particular representative data point, the new data is considered to be a part of the cluster.

Another embodiment of the shell creation process determines a transformation needed to whiten and normalize the data points that comprise a cluster. The intention of this is to generate a latent space in which the cluster is uniformly distributed within a unit sphere. By doing this, the means 230 can determine whether new data points belong to the cluster by performing the same transformation to a new data point and checking whether the transformed data point falls inside or outside of the unit sphere in the latent space. There are many methods for obtaining the whitening transformation, the two most common approaches are Principal Component Analysis (PCA) whitening and Zero-phase Component Analysis (ZCA) whitening. In both cases, the goal is to transform the data such that the resulting data's covariance matrix is equal to the identity matrix. These two approaches are examples of linear whitening transformations which will produce good results for linearly correlated clusters. This will suffice for many real-world applications but will over define the space occupied by nonlinear clusters. For example, applying a linear whitening technique to a cluster shaped like a crescent moon would result in the negative space of the cluster being included in the latent space unit sphere. In order to create accurate definitions of nonlinear clusters, a nonlinear whitening approach should be used to ensure that only the space occupied by the cluster is included in the latent space sphere. Neural nets are typically used for determining the transformations needed for nonlinear whitening and are thus much more computationally expensive than the deterministic linear whitening approaches.

With reference again to FIG. 2, the system 200 can further include means (or second pass module) 240 for performing a second characterization pass on the streaming data 211, 231; the second characterization pass is operative to reevaluate any newly-identified clusters and the inclusion of any of the streaming data therein. The method described above will be sufficient to categorize data if the data is separable in the dimensions being analyzed, but that is not always the case. For example, consider two radar signals which are identical in every way except their pulse repetition interval (PRI); analyzing the pulses individually would result in the two signals being classified as the same thing, but analysis can be done on the resulting aggregate to determine that there are two distinct PRIs present in the cluster. Additionally, in the case of very noisy data, a significant amount of noise could be classified as belonging to actual clusters due to spatial proximity; if the actual members of the cluster are related to each other in time, analysis of the aggregate can be helpful in culling out the noise data points that do not actually belong to a cluster.

In cases where it is necessary or useful, a second pass can be utilized, either periodically throughout the data collection or at the end of a data collection period, to reevaluate the clusters generated and the inclusion of data points within those clusters; doing so will allow three things:
merging neighboring clusters that should be a single cluster;
splitting clusters that contain two distinct categories; and
further discriminating noise from data of interest.
   There are a plurality of approaches that could be taken during this step. Features that were left out of the earlier stages can be leveraged, a reduced feature set can be utilized, or simply an analysis of the same feature set within the confines of a single category. The nature of the second pass will depend on the type of data being processed and any prior knowledge about the incoming data.

The time of arrival (TOA) of a data point is a feature that will generally not be useful during the previous steps of the system, but can be leveraged in a second pass. By looking at the TOA of the data points within a given category, similarities in time or the intervals of incoming data points can be analyzed. Outliers can be reclassified as noise and, if multiple distinct groupings form from this analysis, categories can be split. Further, if two neighboring categories share a similar TOA and interval, those categories can be merged.

Zubaroğlu succinctly compares existing clustering systems for streaming data in the Table 1 and Table 2; the means and corresponding functionalities described in this document have been added to those tables as “System 200”. The systems described in the tables are Adaptive Streaming k-Means, Fast Evolutionary Algorithm for Clustering Data Streams (FEAC-Stream), Multi Density Data Stream Clustering Algorithm (MuDi-Stream), Clustering of Evolving Data Streams into Arbitrarily Shaped Clusters (CEDAS), Improved Data Stream Clustering, David Boulin Index Evolving Clustering Method (DBIECM), and I-HASTREAM. The system 200 is the only system that can find arbitrarily shaped clusters, operate in an online modality, find multi-density clusters, is usable in high dimensions, can find outliers, and does not rely on expert knowledge; these attributes are further explained below.

TABLE 1
Comparison of Data Streaming Classification Methods

| | Base | | Window | Cluster | Cluster |
|---|---|---|---|---|---|
| System | Algorithm | Phases | Model | Count | Shape |
| System 200 | Distance | Online* | None | Auto | Arbitrary |
| | Based | | | | |
| Adaptive | Partitioning | Online | Sliding | Auto | Hyper- |
| Streaming | Based | | | | spherical |
| k-Means | | | | | |
| FEAC-Stream | Partitioning | Online | Damped | Auto | Hyper- |
| | Based | | | | spherical |
| MuDi-Stream | Density | Online- | Damped | Auto | Arbitrary |
| | Based | offline | | | |
| CEDAS | Density | Online | Damped | Auto | Arbitrary |
| | Based | | | | |
| Improved Data | Density | Online- | Damped | Auto | Arbitrary |
| Stream Clustering | Based | offline | | | |
| DBIECM | Distance | Online | None | Auto | Hyper- |
| | Based | | | | spherical |
| I-HASTREAM | Density | Online- | Damped | Auto | Arbitrary |
| | Based | offline | | | |

The systems included in Table 1 can be broken down into three basic types: partition-, density-, and distance-based systems. The system 200, and corresponding functionalities, detailed herein is distance-based, but it distinguishes itself from DBIECM (the other distance-based system), by not relying on a predetermined distance threshold. While DBIECM is restricted to only creating clusters of one size, system 200 dynamically and automatically calculates and changes its distance threshold based on the data being analyzed at a particular data point in time. Generally, partition-based systems rely on a predetermined k value—i.e., the number of clusters present in the data—and have difficulty handling concept drift. This is obviously problematic for streaming data where the number and positioning of clusters can change. The two partition-based systems in the above table, Adaptive Streaming k-Means and FEAC-Stream, attempt to overcome these limitations by dynamically adjusting their k value to account for cluster changes, but they are still limited to hyper-spherical clusters due to the nature of a k-means approach. Density-based systems create micro-clusters of data points which are close together, these micro-clusters are summarized and aggregated with other micro-clusters that are within a certain distance. This approach generally relies on a predefined, static density threshold, which means that this approach does not work well with clusters of varying densities. MuDi-Stream and I-HASTREAM both attempt to overcome this shortcoming by varying the density threshold of each cluster.

The column Phases of Table 1 refers to whether the classification occurs for an online system in real time with the streaming data or if there is an offline system executed periodically that generates the final clustering of the data. An online-offline system by definition creates a significant latency between data ingestion and result output, so a fully online system is desirable. MuDi-Stream, Improved Data Stream Clustering, and I-HASTREAM all operate in an online-offline modality. These three systems are all density-based and follow the same basic online-offline workflow. In their online phase, micro-clusters are formed, and in the offline phase, those micro-clusters are formed into full clusters. The system described in this document is mostly online, meaning that as data is streamed in, it is immediately categorized according to existing clusters, and these results are delivered in real time. The caveat being that new clusters are created offline so there is some latency between a new cluster appearing in the data and that new cluster being added to the system.

The other systems included in this comprison, apart from DBIECM, employ windowing techniques to look at a sampling of the data stream all at once, the system described in this document does not need to use a windowing technique. No windowing means that the entirety of the data stream will be present in the final clustering (in the case of the novel approach, either as a part of a cluster or an outlier). The reason this novel system does not need to use a windowing technique is that each incoming data point is tested against all existing clusters individually. It is only when enough outliers are accumulated that the data is looked at as a group to create a new cluster.

All the systems can automatically add clusters as they appear in the data.

The system described herein creates clusters with arbitrary and concave shapes. Adaptive Streaming k-Means, FEAC-Stream, and DBIECM can only create hyper-spherical clusters and cannot form arbitrary, concave clusters. The ability to create arbitrarily shaped clusters is potentially crucial if a particular feature of a cluster has an abnormal distribution.

Turning now to Table 2, additional metrics for comparison between the disclosed system 200 and other systems are shown.

TABLE 2
Comparison of Data Streaming Classification Methods.

| | Multi | High | | | Expert |
|---|---|---|---|---|---|
| | Density | Dimensional | Outlier | Drift | Knowl- |
| System | Clusters | Data | Detection | Adaption | edge |
| System 200 | Yes | Suitable | Yes | Yes | No |
| Adaptive | Yes | Suitable | No | Yes | No |
| Streaming | | | | | |
| k-Means | | | | | |
| FEAC-Stream | Yes | Suitable | Yes | Yes | Required |
| MuDi-Stream | Yes | Not Suitable | Yes | Yes | Required |
| CEDAS | No | Suitable | Yes | Yes | Required |
| Improved | No | Suitable | Yes | Yes | No |
| Data | | | | | |
| Stream | | | | | |
| Clustering | | | | | |
| DBIECM | Yes | Suitable | No | Yes | Required |
| | (not | | | | |
| | multi | | | | |
| | sized) | | | | |
| I-HASTREAM | Yes | Suitable | Yes | Yes | No |

The system described herein can detect clusters with varying densities. CEDAS and Improved Data Stream Clustering can only detect clusters that meet a constant density threshold and therefore cannot adjust if the nature of the data changes and that threshold no longer detects new clusters. The other distance-based system, DBIECM, can find clusters with varying densities but it is limited to a predefined radius and thus cannot find clusters of varying size. The system described in this document can find clusters of varying size.

None of the exemplary means/methods employed by the system 200 are limited in dimension, so the system as a whole is extensible to n-dimensions and suitable for high dimensional data. MuDi-Stream's processing time is very sensitive to the dimensionality of the data and so it is not suitable for higher dimensional data.

The disclosed system was invented specifically for handling noisy data; it can detect outliers and categorize data points as not being a part of an existing cluster. Adaptive Streaming k-Means and DBIECM are both unable to detect outliers. Every data instance is not forced into a cluster with the disclosed system, so this approach does not share the same shortcoming.

The system described in this document can adapt to concept drift and thus change without being brittle. Clusters are formed dynamically so a cluster consisting of a previously unseen feature set will be detected and categorized, and once created, clusters are not forgotten. A cluster that comes and goes, as illustrated by recurring drift, will not be problematic for this system. Finally, in the case of an incrementally drifting cluster, as a feature set leaves an existing cluster, this system allows for a new neighboring cluster to form following the drift of that feature set. These neighboring clusters can then, if desired by the user, be merged in the second pass portion of the system.

The disclosed system does not require expert knowledge but is able to incorporate any leverageable knowledge the user may have at various data points in the system. FEAC-Stream, MuDi-Stream, CEDAS and DBIECM are all dependent on various hyper-parameters. In order for these systems to cluster effectively these parameters require expert knowledge about the data being processed.

The system described in this document provides a new and novel approach to data classification. It is designed to process streaming data without needing any a priori knowledge about the data stream and is capable of dynamically creating new category (or cluster) types and identifying noise in the data stream. Other systems that attempt to accomplish this same task fall short in one or more areas as shown in the tables above.

The system aims to tackle challenges observed in existing algorithms by incorporating features such as memory of previously found classes, handling noisy data streams and maintaining accurate cluster definitions, and the ability to find many, one, or no clusters in each search, and supporting real-time processing.

The system is applicable to a variety of domains, including education, simulation analysis, performance monitoring, and control/operation/maintenance of real-time systems. The system could be leveraged in healthcare domains to cluster on patient symptoms and demographics to find macro trends or on the individual level it could be used to cluster on sensor data from a patient's vitals to detect anomalous behavior or find unobvious, high-dimensional trends and provide remedial measures. The system could be used by the intelligence community to automatically detect and categorize adversary's radar reserved modes by clustering on features from radar pulse descriptor words and provide countermeasures. At a high level, this system is designed for situations in which the categories present in the user's data are subject to change or the user does not have any insight into what the data may contain.

The unsupervised clustering algorithm can be extended beyond implementation of the Delaunay triangulation. At a high level, a triangulation subdivides the space occupied by a data point set into simplices (in 2-dimensions, triangles) whose vertices are the data points within the set. The Delaunay triangulation is a triangulation whose simplices' smallest interior angle is maximized. This avoids slivers and encourages equilateral simplice. Alternatives include a drop-in alternative for Delaunay triangulations that would generate similarly dynamic neighbor relationships but also scaled well to high dimensions. The system includes extended computations from a Parzen Window Density Estimation to achieve the same functionality provided by triangulation. The Parzen Window Density Estimation provides a way to determine a continuous density for a discrete set of data points using a sliding window function. With this, the system provides tests in higher dimensions.

The default settings can produce good results on a wide range of datasets. The system can run on a data stream, without tuning to get good results. The system allows for enhanced results with some tuning, but the system should perform well with the default settings in any environment. The system should provide a stable set of hyperparameters in higher dimensions (e.g., beyond two to five dimensions). The system converged over time to an algorithm similar to, but very different than Campello, Moulavi, and Sander's HDBSCAN (Campello, Moulavi, and Sander, 2013). While the implementation shares some common features with HDBSCAN, the system is more robust and efficient to handle high data throughput in real time. To this end, the system is parallelized using ParlayLib (Blelloch, Anderson, Dhulipala, 2020), a highly efficient scheduler and parallel algorithm implementation to obtain a parallel infrastructure.

The logic of the system disclosed herein builds off HDBSCAN and the implementation of the system builds on the implementation described in Fast Parallel Algorithms for Euclidean Minimum Spanning Tree and Hierarchical Spatial Clustering (Wang, Yu, Gu, and Shun, 2021). At a high level HDBSCAN, and by extension the system (via the unsupervised clustering module 230) disclosed herein uses a minimum spanning tree (MST) to determine critical distance thresholds that correspond to candidate clusters gaining or losing data points and candidate clusters splitting or merging with each other. In graph theory, a graph refers to a group of vertices and the edges that link them. The vertices are individual data points, and the edges are the distances between two data points. A connected graph is a graph in which there is a continuous path between any pair of vertices.

A spanning tree is a subset of connected graphs in which there exists one, and preferably only one, path between any pair of vertices. That is, there are no cycles or loops in the graph. Further, a minimum spanning tree is the spanning tree with the lowest combined edge weight possible. With the MST, a dendrogram or binary tree of potential clusters can be constructed and then culled into the final designations (via the unsupervised clustering module 230). A dendrogram is a tree representation often used in hierarchical clustering to represent similarity in potential clusters. With a dendrogram, it is possible to determine threshold(s) below which clusters are defined. The system disclosed herein is the application of each of these parts of the unsupervised clustering process, and how the MST and dendrogram are used to make the cluster definitions.

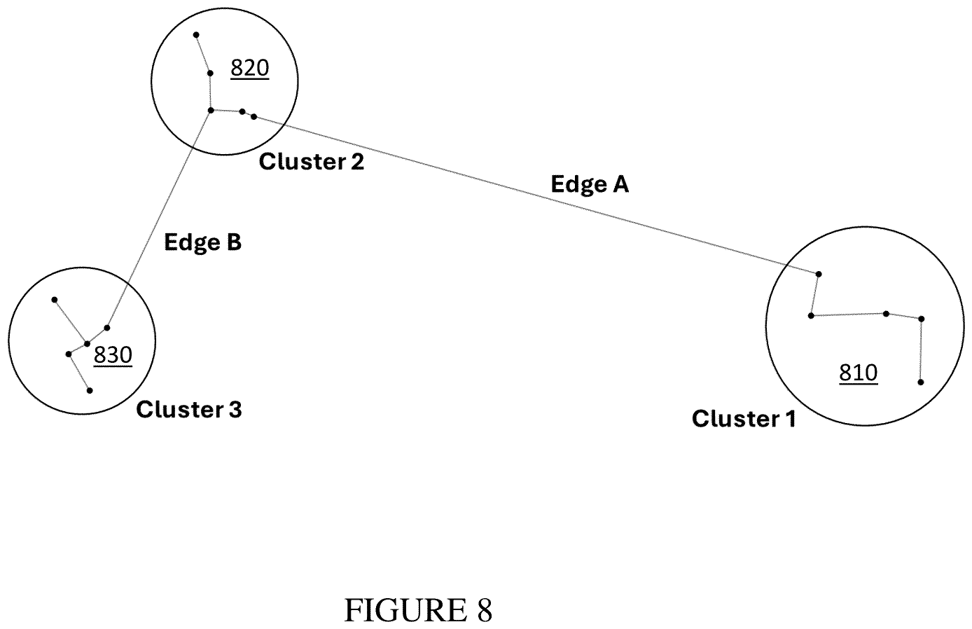

FIG. 8 illustrates an exemplary minimum spanning tree of a three-cluster dataset. In the context of clustering, an MST is a useful structure because each edge represents the precise distance at which a data point or group of data points split away from a cluster. There is no need to guess at distance thresholds, every useful threshold is baked into the tree. To make cluster determinations, the edges of the MST are observed, from largest to smallest, and analyzed for the data points each edge connects. In this case, it is observed that edges A and B are the critical edges whose removals make the three clusters 810, 820, 830 distinct.

From a computational standpoint, building the MST is by far the most extensive part of the clustering process, and increasing the efficiency of that process has been beneficial. The concept of core distances and mutual reachability is used in the MST construction. This behavior is controlled by the minimum data points hyperparameter. A data point's core distance is determined by the distance between itself and its kth nearest neighbor where k equals minimum data points and the mutual reachability of two data points is defined as the maximum value between each of the data point's core distances and the actual distance between the two data points or |ab|=max(dist(a, b), a_{core}, b_{core}).

The first step in the MST construction is to determine the core distance for each data point within the dataset, following, for instance, Wang's implementation. A k-d tree is constructed whose splits correspond to the median of the widest dimension of the subtree at that split. The k-d tree is used to efficiently find the kth nearest neighbor of each data point and with that the core distance of each data point.

Next, a well-separated pair decomposition (WSPD) is used to inform the edge search. A set of data points A is well-separated from data point set B if for each set there exists a hypersphere of radius r such that each hypersphere fully encapsulates their data point set and the hyperspheres are at least s*r distance apart where s>0. The well-separated pair decomposition of data point set S is the series of well-separated pairs, (A₁, B₁), (A₂, B₂), (A₃, B₃), . . . , (Aₘ, Bₙ), such that for any pair of data points in S there exists only one pair, (Aᵢ, Bᵢ), in which Aᵢ contains one of the data points and Bᵢ contains the other. The well-separated pair decomposition allows judicious distance calculations and greatly reduces the amount of computation needed to generate the MST. During the tree building process, three variables are tracked to limit the edge search for a particular iteration, β, ρ_{low}, and ρ_{high}. An exemplary algorithm flow to build the MST is set forth below.

```
rho_low = 0; beta = 4;
while(tree.Incomplete) {
  rho_high = CalcRhoLimit(beta);
  while (edges > 0) {
    edges = GetEdges(beta, rho_low, rho_high);
    AddEdges(edges, tree);
  }
  beta *= 2.0;
  rho_low = rho_high;
}
```

In each outer loop, the system doubles the β value and replace ρ_{low} with the value of ρ_{high} determined during CalcRhoLimit. GetEdges returns edges that connect two well-separated pairs whose combined size is less than or equal to β and whose edge weights are between ρ_{low} and ρ_{high}. These edges are then added to the MST.

CalcRhoLimit determines a new ρ_{high} value by finding the minimum possible bichromatic closest pair (BCP) distance between any well-separated pairs whose combined size is greater than β. The biochromatic closest pair of two disjoint (nonoverlapping) sets is the pair of data points, one from each set, which are minimally separated. Because an exact BCP calculation is extensive, a lower bound can be used given by the distance between the bounding boxes that enclose each set in the well-separated pair. In GetEdges, all the well-separated pairs are observed whose combined size is at most β and whose constituents belong to separate components of the in-progress graph. During the MST build process, the in-progress tree will be a spanning forest, or set of disjoint trees, and each tree is a referred to as a component. If each set in a well-separated pair is part of the same component, there is no need to further analyze the pair as the data points within them are already fully connected.

While searching, a record is retained of the minimum connecting edge found so far in the current round for each component of the graph. If the minimum possible BCP distance between the two pairs is less than ρ_{high} and less than the current edge for any of the components contained in the pair, the exact BCP is calculated. If the exact BCP distance is less than ρ_{high} and the current best for either of the components that it connects, it is recorded. The BCP calculation for pairs is limited to be smaller than β because it is more judicious to find the BCP for smaller well-separated pairs. The evaluation of pairs is limited to the potential BCP distance that is less than ρ_{high} to ensure that the system only adds valid edges to the tree. The MST building process uses the implementation presented by Wang as a starting data point (a more detailed look at this approach can be found in that reference). The system strays from Wang's implementation in a few places and these deviations provide a significant reduction in computation time and processing power.

The system is judicious as to the number of full BCP calculations. During the edge search, the system maintains the current best edge for every component in the graph. With this information, the system considers a well-separated pair, and whether its minimum possible BCP is less than the current best edge for any component within either set. At the end of GetEdges, a set of edges is determined that all belong to the MST, whereas the implementation presented by Wang oversamples exact BCP calculations and each edge search returns edges that may or may not actually belong to the MST. The system has features that resemble Boruvka's algorithm while Wang's implementation utilizes a batched Kruskal's algorithm approach. Boruvka's algorithm generates an MST in rounds by finding the minimum edge connection for each component in the existing graph. Through this approach, the number of components will decrease each round by at least half and the algorithm terminates when there is only a single component. At a high level, Kruskal's algorithm sorts candidate edges by weight, then iterates through each, from smallest to largest, checking whether adding that edge to the graph will result in a loop and adding the edge if it does not or discarding the edge if it does. Once the graph is fully connected, the system terminates.

The system automatically adds each data point's nearest neighbor to the MST after calculating the core distance values for each data point. The nearest neighbor is determined with the core distance calculation and the nearest neighbor is part of the MST, even when minimum datapoints are greater than one. The system streamlines some code paths, cache repeatedly used and expensive values, and makes other similar bookkeeping enhancements.

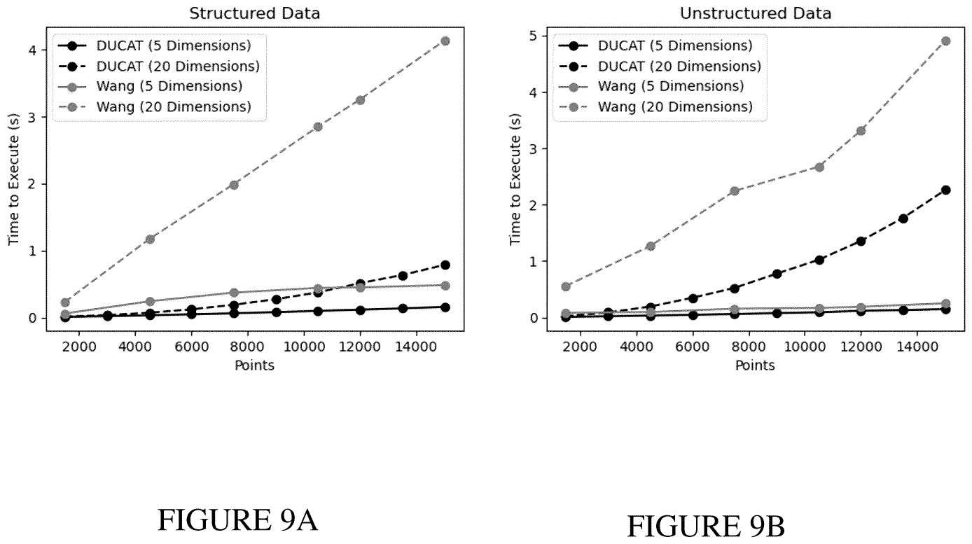

FIGS. 9A and 9B illustrate exemplary graphical representations of timing comparisons (in seconds (s) on the vertical axis) verses a number of data points (on the horizontal axis) between Wang's implementation and the implementation for structured and unstructured data with datasets of varying sizes according to the system disclosed herein. These tests, and all other timing tests herein, were performed on a c5.4xlarge Amazon AWS EC2 instance running Amazon Linux 2023. This instance type has 16 vCPU and 32 GiB of memory. The structured dataset include three semi-overlapping gaussian clusters with varying standard distributions. These datasets are generated using sklearn's make blobs function. The unstructured datasets include uniform distributions of noise. Five versions of each data point-dimension pair for each dataset type were generated with different random seeds. Each data point on the plot represents the average time to execute across ten trials for each of the five datasets for that data point-dimension pair.

The code for the Wang implementation was run without modification except for a minor fix to its parallel buffer code that resulted in a segmentation fault and the removal of print statements. It should be noted that there are concepts described in their paper that are not implemented in the code, notably a method for caching previously calculated BCP's. Additionally, the running tests on datasets is limited to twenty or fewer dimensions as Wang's implementation hardcodes the number of dimensions and is not extensible to n-dimensions as written.

The system disclosed herein is at least 1.5 times faster (12,000 data points, 5 dimensions unstructured data) and at most 24 times faster (1,500 data points, 20 dimensions unstructured data). On average the system is 8 times faster for unstructured data, 5 times faster for structured data, 4 times faster in 5 dimensions, and 9 times faster in 20 dimensions.

In an alternative embodiment, the system generates an approximate MST instead of an exact MST as described previously. A reasonably accurate MST approximation will provide enough information to generate a clustering of the same quality as the exact MST. One exemplary approach to generating an approximate MST is NN-Descent (Dong, Charikar, Li, 2011), but there are a plurality of methods for producing the approximation. The determination of whether to use an approximation technique or determine the exact MST will depend on the data stream being analyzed. Cases with low-dimensional data or a low data rate can be processed quicker by determining the exact MST while approximation techniques are better suited for high-dimensional or high data rate situations.

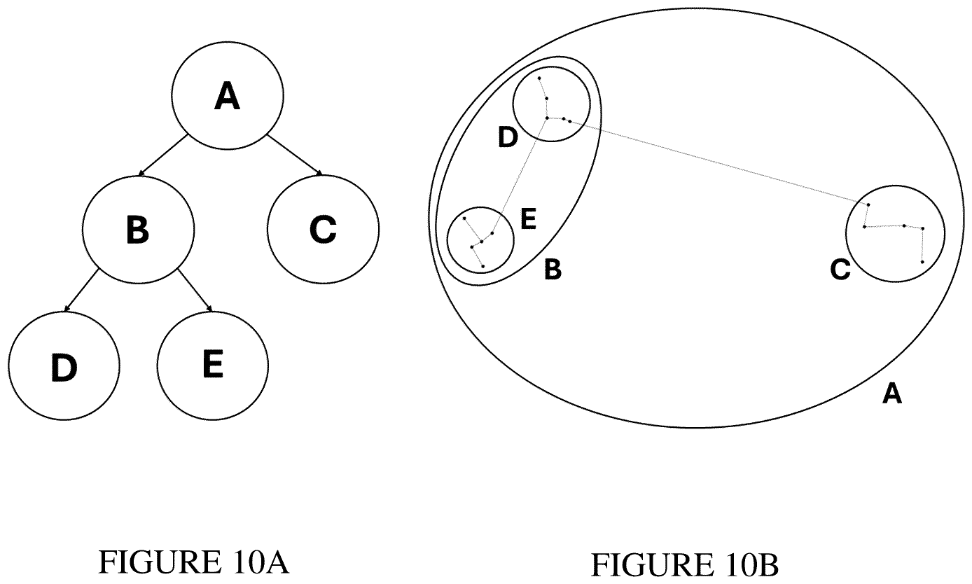

Once the MST is built, a dendrogram (via the unsupervised clustering module 230) is formed to make cluster definitions. Taking the dataset from FIG. 8, a dendrogram is built including five candidate clusters. FIG. 10A illustrates an exemplary dataset's dendrogram, and FIG. 10B illustrates exemplary data points that make up each of the five clusters Cluster A, B, C, D, E. Cluster A is the root node and includes the entire dataset, it splits into Clusters B and C, and Cluster B eventually splits into Clusters D and E. The dendrogram provides a mechanism to navigate and observe a hierarchy of potential clusters within a dataset.

Building the dendrogram is relatively straightforward and follows the implementation provided by Wang. First, the edges of the MST are sorted by weight. Then, the system iterates through each edge and for each determines the two components that edge connects using a union-find data structure. A union-find data structure stores a collection of disjoint sets. For purposes herein, an implementation is set forth that efficiently determines the set a data point belongs to, and efficiently merges two sets. This data structure is used throughout the algorithm and allows tracking of components during the MST and dendrogram build processes. The newly formed cluster is recorded, the two children that edge merged, the size of the new cluster, and the edge weight. With the dendrogram, the system determines the clusters.

The dendrogram is condensed based on a minimum cluster hyperparameter that defines the minimum number of data points needed for a cluster to be reportable. The remaining nodes represent the dataset's candidate clusters. The concept of stability is used defined by HDBSCAN and the excess of mass algorithm to cull these clusters. Every node in the dendrogram has a stability, and a cluster is valid by iterating through the dendrogram from the bottom up and comparing each node's stability to the combined stability of its children. If the parent's stability is greater than the combined stability of its children, the parent is retained and every node below the parent is discarded. If the children's combined stability is greater than the parent's, the parent's stability is set to the combined stability of the children and the parent cluster is discarded. The term λ is defined

$$λ = \frac{1}{split distance} ,$$

where the split distance corresponds to an edge weight in the MST.

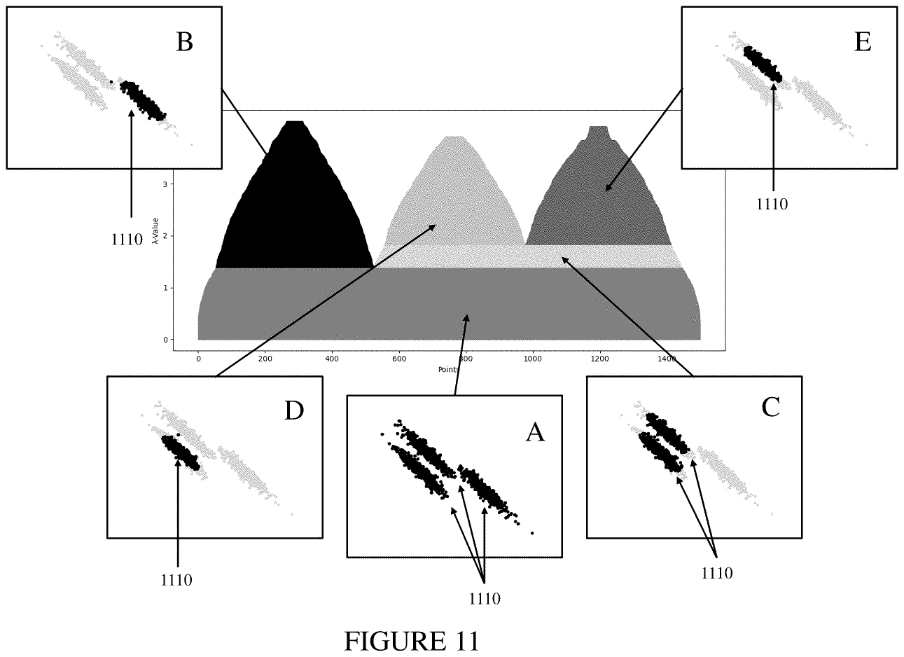

Every cluster in the dendrogram will have a λ_{death} corresponding to the at which the cluster's children merge and a λ_{birth} corresponding to the λ at which the cluster merges with its sibling into their parent cluster. The root node does not have a “birth” in the same way that the other nodes in the dendrogram have—its birth is λ=0. Similarly, the leaf nodes do not have a “death” in the same way that other nodes do, their death occurs when they become smaller than the minimum cluster hyperparameter. Additionally, each data point within the cluster will have a λ value, λ_{birth}≤λ≤λ_{death}, that corresponds to the edge that joins the data point to the cluster. The cluster's stability (performed by the unsupervised clustering module 230) can then be defined as Σ_{p∈cluster}(λₚ−λ_{birth}). To understand what this culling approach is doing and why it is called “excess of mass,” it is useful to visualize the dendrogram with the graph of FIG. 11.

FIG. 11 illustrates an exemplary plot demonstrating the relationship between λ and the resulting clusters for a λ-value for a three-cluster dataset. Each unit on the x-axis corresponds to a data point within the dataset and the y-axis corresponds λ, each area in the plot represents a different cluster Cluster A, B, C, D, E in the dendrogram hierarchy. The number of data points in a cluster at a given λ is given by the cluster's width at that y-value. With this plot the effect of raising and lowering λ thresholds have on the number and size of the resulting clusters can be observed. The stability of each cluster is the area (“mass”) of darker shading in their respective regions (also generally designated 1110 within each region). When stability comparisons are made to cull candidate clusters, the area that each cluster occupies on the graph are compared.

The culling process (via the unsupervised clustering module 230) described up to this point may be improved. A first limitation is that the root node of the dendrogram tends to have a much greater stability than the rest of the cluster tree. HDBSCAN's response to this is a toggle that allows a user to automatically discount the root node. The effect of this toggle is that if the root node is discounted, the algorithm finds clusters and structure in datasets which have none and, if the root node is not discounted, the algorithm tends toward defining the entire dataset as a single cluster. The problem with this approach is that it either requires some apriori knowledge that clusters exist in the dataset, or it requires some kind of feedback, human or automated, to determine whether the toggle should be on or off on a per-dataset basis. The system herein targets real-time applications where human intervention is not an option. Additionally, if the number of clusters in a data stream is constant, and they have all been identified by the system, the unsupervised clustering algorithm will only be looking at noise and it needs to be able to consistently identify unstructured datasets as containing only noise. The response to this problem is to limit the root node by defining a floor for the root node and only including the area above that floor in its stability calculation. The floor may be implemented at 60% of the root node's λ_{death}. This value has been an effective level that allows for unstructured data to be identified as such, while still allowing cluster definitions when they should occur.

Another limitation of HDBSCAN's approach to labeling is that clusters are defined just before their birth, or right before they merge into their parent. The problem with this approach becomes evident in noisy datasets. The clusters will pick up noise data points in the interstitial space between each other before merging. If cluster definitions are defined properly before they merge, it will lead to loose definitions that encompass much more than is appropriate. The solution to this can be best visualized with a similar versus cluster size plot shown in FIG. 11. This time focus on a single cluster, and instead of mirroring the cluster growth the system simply looks at the relationship between and the size of the cluster. The system can then determine what the plot would look like if it had the same stability, and initial and final sizes but grew linearly with respect to λ. The λ value of the right-most intersection between the linear plot and the actual plot gives a threshold to cut the cluster growth. The logic behind this approach is that a cluster's growth will be regular while expanding within itself, plateau once the cluster is fully encompassed, and then experience sudden growth after expanding into the surrounding noise. By reducing the λ threshold in this way, the system can step over the concavity associated with a loosely defined cluster.

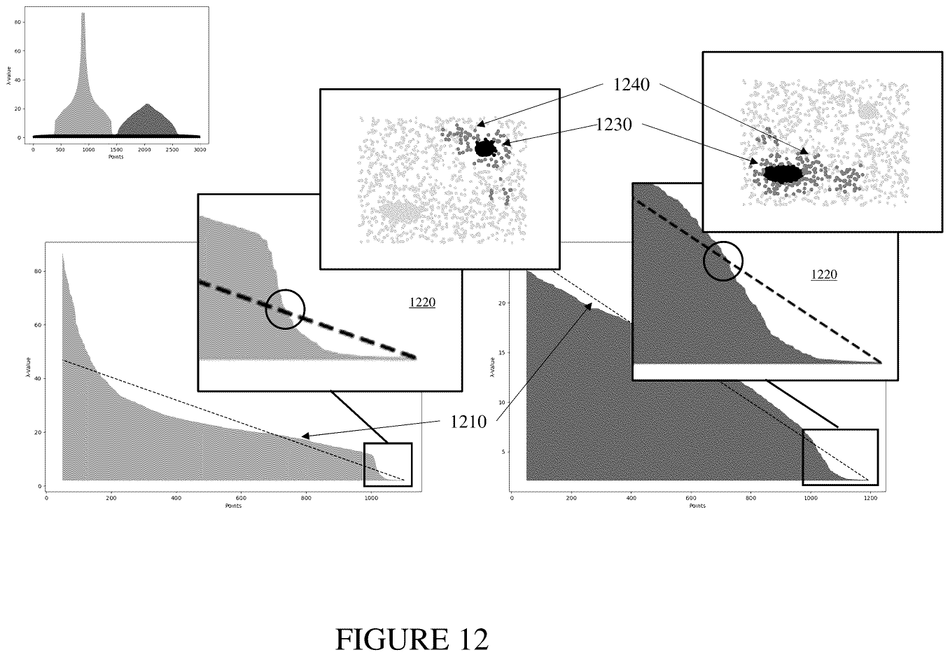

FIG. 12 illustrates an exemplary plot for a noisy dataset containing two distinct clusters. The dotted line 1210 shows the calculated linear growth line, and the insets 1220 show the concavity that appears when a cluster begins to expand into surrounding noise. Each scatter plot shows the data points to the left of the intersection between the linear growth line and the actual growth curve in darker shaded regions (also designated 1230) and the data points to the right of that intersection in lesser shaded regions (also designated 1240).

As a third issue when making a cluster determination, HDBSCAN will either keep the node or both of its children. It does not have a mechanism for only keeping one of the node's children. In a well-formed dendrogram, this is not usually a problem, but having a well-formed dendrogram requires hyperparameters that fit the particular dataset being analyzed. The goal is to have an algorithm whose default hyperparameters have a high level of stability. When there is the luxury of parameter tuning, a particular data stream can be optimized, but otherwise, the objective is to be performant. As such, ill-formed dendrograms should be successfully addressed.

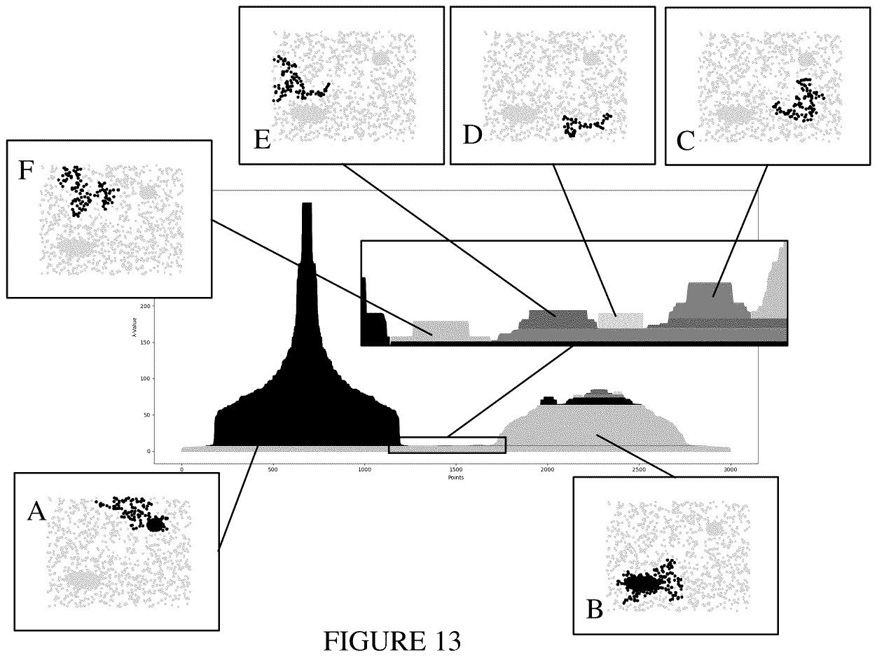

FIG. 13 illustrates an exemplary plot of an ill-formed dendrogram. Clusters A and B are the clusters of interest, but HDBSCAN's culling strategy would result in Cluster's C, D, E and F being counted as valid. The implementation of the system herein (via the unsupervised clustering module 230) is to allow a third option when considering a node in the dendrogram by keeping the parent, both children, or only a single child. The decision regarding the parent is the same way described above. If the parent's stability is greater than the combined stability of the children, the parent is retained. If not, it is determined whether the children represent two distinct clusters or a single distinct cluster with a hanger-on.

This is analyzed by first calculating the average stability contribution of a single data point within each cluster (stability/size), followed by taking the ratio of the smaller cluster's average stability contribution to that of the larger cluster,

$$\frac{{( stability / size )}_{smaller}}{{( stability / size )}_{larger}} .$$

If that ratio is greater than a preset threshold both clusters are retained and, if not, the larger cluster is retained. The average stability contribution is analyzed to allow small, but distinct, clusters in close proximity to much larger clusters to be identified and a ratio of the two values is analyzed so that the threshold is able to generalize to a wide range of datasets. In tests, it has been observed that there is a wide band between the ratios of two legitimate clusters and the ratios of a single legitimate cluster and a hanger-on with the properly selected threshold value.

With this approach to unsupervised clustering, structured and unstructured datasets can be evaluated, maintaining tight cluster definitions, and reducing the number of extraneous cluster definitions generated all while executing very rapidly and leveraging parallel processes. Again, reducing computation time and processing power of the system. Comparisons between the algorithm (forming the system herein) and other unsupervised clustering algorithms can be seen transitively through the benchmark comparisons presented in HDBSCAN's documentation (McInnes, Healy, and Astels, 2016). Two data points of focus for comparison are noise rejection and speed.

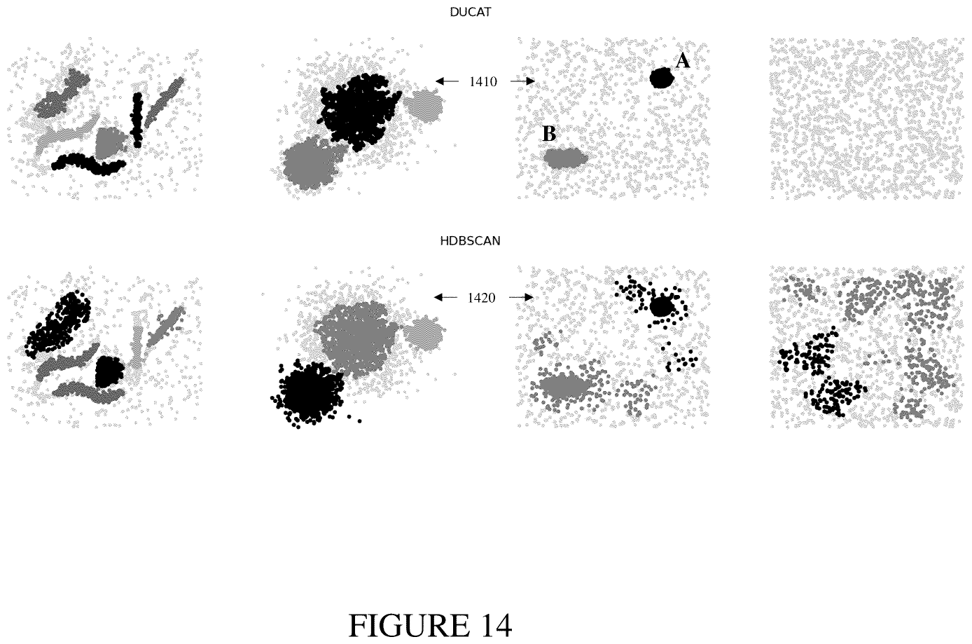

FIG. 14 illustrates an exemplary plot of a labelling comparison of noise rejection between the system and method disclosed herein and HDBSCAN. The top row 1410 shows the labels for the algorithm of the system herein and the bottom row 1420 the labels generated by HDBSCAN. Data points labeled as noise are colored gray. Both algorithms could produce better results for each individual dataset if they were tuned specifically for that dataset, but a static hyperparameter set was selected for each algorithm based on the parameters that gave the best, overall results (for system disclosed herein: minimum cluster=60, minimum data points=10, for HDBSCAN: minimum cluster=80, minimum data points=35). Note that both algorithms can find arbitrarily shaped clusters, clusters of varying densities, and clusters with significant overlap. But algorithm of the present system is able to do all of that and maintain tight cluster definitions (Clusters A and B) in the face of significant background noise and effectively determine when no clusters exist, all with a single set of hyperparameters.

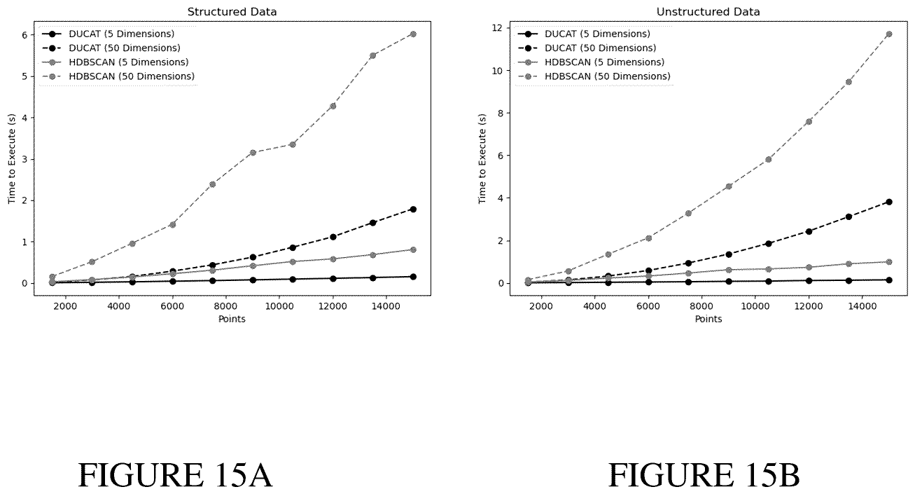

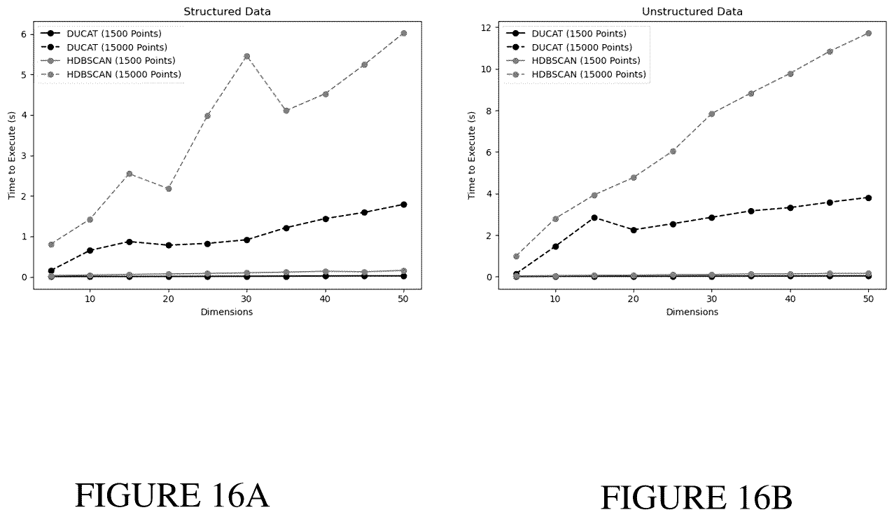

FIGS. 15A and 15B illustrate exemplary plots of time to execute comparisons across dataset lengths with a fixed dimension for structured and unstructured data, respectively. FIGS. 16A and 16B illustrate exemplary plots of time to execute comparisons across dimensions with a fixed dataset length for structured and unstructured data, respectively. On the surface, a timing comparison between the present system and HDBSCAN's Python library seems unfair, but their implementation is largely written in Cython, which can produce performance comparable to C, and the Python library is the official implementation. For the timing benchmarks, the same structured and unstructured datasets were used for benchmarking the performance difference between the present system and Wang's implementation. Across all 100 dimension-point pairs tested, the present system was on average 4.1 times faster (e.g., between 1.4 times faster and 8.1 times faster) than HDBSCAN. For the structured datasets, the present system was on average 4.9 times faster, and for the unstructured datasets, the present system was on average 3.3 times faster.

The present system is better equipped to handle noisy and high-dimensional data. The unsupervised clustering algorithm is highly capable as a stand-alone algorithm, but also slots into a system architecture. The algorithm's ability to handle totally unstructured data as well as noisy structured data all with a single set of hyperparameters offer distinct benefits for clustering in dynamic and noisy environments.

The following references, and all references herein, are incorporated herein by reference.
Blelloch, G. E., Anderson, D., Dhulipala, L. (2020). ParlayLib—A Toolkit for Parallel Algorithms on Shared-Memory Multicore Machines. 32nd ACM Symposium on Parallelism in Algorithms and Architectures (SPAA '20). Association for Computing Machinery, New York, NY, USA, 507-509. https://doi.org/10.1145/3350755.3400254.
Campello, R. J. G. B., Moulavi, D., Sander, J. (2013). Density-Based Clustering Based on Hierarchical Density Estimates. In: Pei, J., Tseng, V. S., Cao, L., Motoda, H., Xu, G. (eds) Advances in Knowledge Discovery and Data Mining. PAKDD 2013. Lecture Notes in Computer Science, vol 7819. Springer, Berlin, Heidelberg. https://doi.org/10.1007/978-3-642-37456-2_14.
De Loera, J., Rambau, J., and Leal, F., (2003), Triangulations of Point Sets, https://personales.unican.es/santosf/MSRI03/chapter1.pdf.
Heinlen, C., Volpi, M., Allen, R. (2023). A Novel Approach to Dynamic Unsupervised Clustering. 2023 Interservice/Industry Training, Simulation, and Education Conference (I/ITSEC 2023), https://www.xcdsystem.com/iitsec/proceedings/index.cfm?Year=2023&CID=1001&AbID=1209 27.
Heinlen, C., Volpi, M., Allen, R. (2024). An Enhanced Approach to Dynamic Unsupervised Clustering. 2024 Interservice/Industry Training, Simulation, and Education Conference (I/ITSEC 2024), https://www.xcdsystem.com/iitsec/proceedings/index.cfm?Year=2024.
McInnes, L., Healy, J., & Astels, S. (2016). HDBSCAN Documentation. The HDBSCAN Clustering Library. https://hdbscan.readthedocs.io/en/latest/index.html.
Wang, Y., Yu, S., Gu, Y., & Shun, J. (2021). Fast Parallel Algorithms for Euclidean Minimum Spanning Tree and Hierarchical Spatial Clustering. 2021 International Conference on Management of Data (SIGMOD '21). Association for Computing Machinery, New York, NY, USA, 1982-1995. https://doi.org/10.1145/3448016.3457296.
Dong, W., Charikar, M., Li, K. (2011). Efficient K-Nearest Neighbor Graph Construction for Generic Similarity Measures. 20^{th} International Conference on World Wide Web, WWW 2011. https://doi.org/10.1145/1963405.1963487.
Zubaroglu, A. and Atalay, V., (2020), Data Stream Clustering: A Review, https://doi.org/10.48550/arXiv.2007.10781.

Although the embodiments and its advantages have been described in detail, it should be understood that various changes, substitutions, and alterations can be made herein without departing from the spirit and scope thereof as defined by the appended claims. For example, many of the features and functions discussed above can be implemented in software, hardware, or firmware, or a combination thereof. Also, many of the features, functions, and steps of operating the same may be reordered, omitted, added, etc., and still fall within the broad scope of the various embodiments.

Moreover, the scope of the various embodiments is not intended to be limited to the embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized as well. Accordingly, the appended claims are intended to include within their scope such processes, machines, manufacture, compositions of matter, means, methods, or steps.

What is claimed is:

1. A data categorization system for dynamically categorizing streaming data into data clusters, said system having no prior knowledge of said data clusters to which said streaming data can be assigned, said data categorization system being operable on a processor and memory configured to:
check said streaming data against known data clusters and assign ones of said streaming data that fit said known data clusters thereto, otherwise categorize said ones of said streaming data as unclassified data;
execute unsupervised clustering on said unclassified data when said unclassified data reaches a threshold, said unsupervised clustering configured to:
generate a minimum spanning tree of said unclassified data,
generate a dendrogram from said minimum spanning tree including nodes having ones of said unclassified data,
determine which nodes are viable as new data clusters, and
cull noise and extraneous ones of said unclassified data from said new data clusters, said unsupervised clustering producing a transformed and reduced set of said unclassified data within said new data clusters;
define shells for said new data clusters, configured to:
determine a transformation that forces said unclassified data into a unit sphere or cube,
apply said transformation to each of said unclassified data, and
assign any of said unclassified data that fall within said unit sphere or cube to said shells for said new data clusters;
said shells including a transformed and reduced set of said unclassified data to add to said known data clusters; and
output said new data clusters to a data analysis system to execute a model to operate a real system with computational efficiency in real-time.

2. The data categorization system as recited in claim 1 wherein said minimum spanning tree is an approximate minimum spanning tree

3. The data categorization system as recited in claim 1 wherein said processor and said memory are configured to generate said minimum spanning tree by determining a core distance for each of said unclassified data and adding a nearest neighbor to each of said unclassified data to said minimum spanning tree.

4. The data categorization system as recited in claim 1 wherein said dendrogram is condensed based on a minimum cluster hyperparameter that defines the minimum number of said unclassified data for a new data cluster.

5. The data categorization system as recited in claim 1 wherein a node is viable if a stability of said node is greater than a combined stability of children nodes from said node, said children nodes being discarded.

6. The data categorization system as recited in claim 1 wherein said processor and said memory are configured to cull by setting a floor for inclusion of said ones of said unclassified data within said new data clusters and cull said noise and said extraneous ones from said unclassified data below said floor from said new data clusters.

7. The data categorization system as recited in claim 1 wherein said processor and said memory are configured to cull to reduce a number of said new data clusters.

8. The data categorization system as recited in claim 1 wherein said processor and said memory are configured to cull to reduce a size of said new data clusters by setting a λ threshold for each of said unclassified data to equal a λ value λ_{birth}≤λ≤λ_{death}, wherein λ relates to an edge weight of said minimum spanning tree.

9. The data categorization system as recited in claim 1 wherein said processor and said memory are configured to determine said transformation by performing a principal component analysis whitening or a zero-phase component analysis whitening.

10. The data categorization system as recited in claim 1, wherein said processor and said memory are further configured to perform a second characterization pass on said streaming data, said second characterization pass operative to reevaluate any new data clusters and inclusion of any of said unclassified data therein.

11. A method of operating a data categorization system for dynamically categorizing streaming data into data clusters, said data categorization system having no prior knowledge of said data clusters to which said streaming data can be assigned, said method, comprising:
checking said streaming data against known data clusters and assign ones of said streaming data that fit said known data clusters thereto, otherwise categorize said ones of said streaming data as unclassified data;
executing unsupervised clustering on said unclassified data when said unclassified data reaches a threshold, comprising:
generating a minimum spanning tree of said unclassified data,
generating a dendrogram from said minimum spanning tree including nodes having ones of said unclassified data,
determining which nodes are viable as new data clusters, and
culling noise and extraneous ones of said unclassified data from said new data clusters,
said unsupervised clustering producing a transformed and reduced set of said unclassified data within said new data clusters;
defining shells for said new data clusters, comprising:
determining a transformation that forces said unclassified data into a unit sphere or cube,
applying said transformation to each of said unclassified data, and
assigning any of said unclassified data that fall within said unit sphere or cube to said shells for said new data clusters;
said shells including a transformed and reduced set of said unclassified data to add to said known data clusters; and
outputting said new data clusters to a data analysis system to execute a model to operate a real system with computational efficiency in real-time.

12. The method as recited in claim 11 wherein said minimum spanning tree is an approximate minimum spanning tree

13. The method as recited in claim 11 further comprising generating said minimum spanning tree by determining a core distance for each of said unclassified data and adding a nearest neighbor to each of said unclassified data to said minimum spanning tree.

14. The method as recited in claim 11 wherein said dendrogram is condensed based on a minimum cluster hyperparameter that defines the minimum number of said unclassified data for a new data cluster.

15. The method as recited in claim 11 wherein a node is viable if a stability of said node is greater than a combined stability of children nodes from said node, said children nodes being discarded.

16. The method as recited in claim 11 wherein said culling further comprises setting a floor for inclusion of said ones of said unclassified data within said new data clusters and cull said noise and said extraneous ones from said unclassified data below said floor from said new data clusters.

17. The data categorization system as recited in claim 11 wherein said culling reduces a number of said new data clusters.

18. The method as recited in claim 11 wherein said culling further comprises reducing a size of said new data clusters by setting a λ threshold for each of said unclassified data to equal a λ value λ_{birth}≤λ≤λ_{death}, wherein λ relates to an edge weight of said minimum spanning tree.

19. The method as recited in claim 11 wherein said determining a transformation further comprises performing a principal component analysis whitening or a zero-phase component analysis whitening.

20. The method as recited in claim 11 further comprising performing a second characterization pass on said streaming data, said second characterization pass operative to reevaluate any new data clusters and inclusion of any of said unclassified data therein.
